(19) United States
(12) Patent Application Publication
(10) Pub. No.: US 2017/0322789 A1
(43) Pub. Date: Nov. 9, 2017

(54) SYSTEM AND METHOD FOR AUTOMATICALLY INSTALLING APPLICATION

(71) Applicant: HON HAI PRECISION INDUSTRY CO., LTD., New Taipei (TW)

(72) Inventor: CHAO-TSUNG FAN, New Taipei (TW)

(21) Appl. No.: 15/163,668

(22) Filed: May 25, 2016

(30) Foreign Application Priority Data
May 4, 2016 (CN) 201610287718.2

(51) Int. Cl. G06F 9/445

(52) U.S. Cl. CPC G06F 8/61

(57) ABSTRACT

A system for automatically installing applications across a plurality of electronic devices, each with own serial number, includes a control server, a storage server, and at least one electronic device needing an application to be installed. The control server includes a system preloading unit. The storage server stores a plurality of installation files. The system preloading unit preloads an application installation system in the electronic device. The application installation system includes a unit to discover serial number of the electronic device. The control server searches for complete and corresponding installation files in the storage server, based on the serial number, and installs such application in the electronic device.

### CROSS-REFERENCE TO RELATED APPLICATIONS

This application claims priority to Chinese Patent Application No. 201610287718.2, filed on May 4, 2016, the contents of which are incorporated by reference herein.

### FIELD

The subject matter herein relates to a system and method for automatically installing applications in computing devices.

### BACKGROUND

In some prior art systems, installation of application programs and operating systems is accomplished by discovering information about the hardware on the system, copying and decompressing source files, installing those files through such methods as library registration, and then configuring those installed files based on user input. This installation process is typically time consuming and many of the actions, particularly in the installing files phase, are the same regardless of the system that the application or operating system is being installed on. With these prior art systems, discovering system information, copying and decompressing files, installing and registering files, and configuring user desires requires a significant length of time. Such systems lack a method for performing common installation actions once only for a plurality of computers.

### BRIEF DESCRIPTION OF THE DRAWINGS

Implementations of the present technology will now be described, by way of example only, with reference to the attached figures.

FIG. 1 is a diagrammatic view of a system for automatically mounting applications for installation in a computing device.

FIG. 2 is a block view of a control server of the system of FIG. 1.

FIG. 3 is a block view of an electronic device of the system of FIG. 1.

FIG. 4 is flow chart of a method for automatically mounting applications.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, serial, and the like.

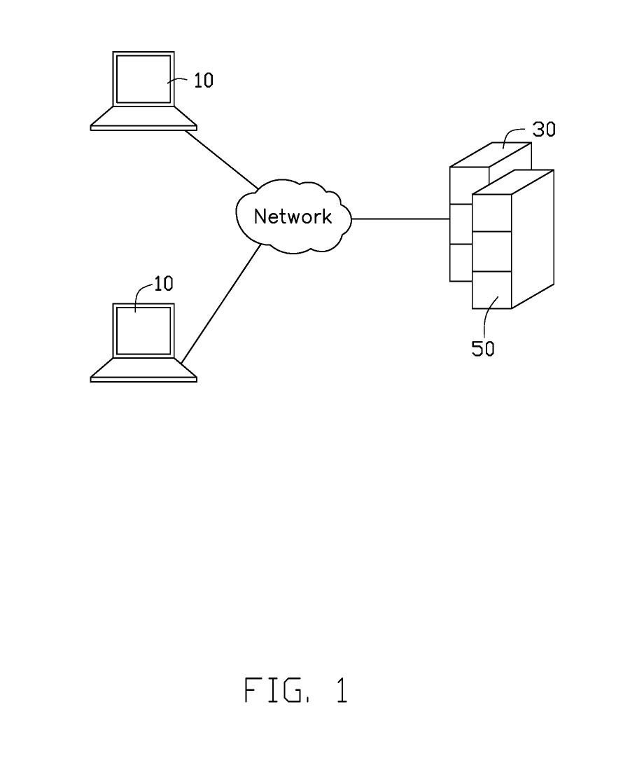

FIG. 1 illustrates a system for automatically installing applications. The system includes a plurality of electronic devices 10, a control server 30, and a storage server 50. Applications are needing to be installed in the plurality of electronic devices 10, the applications to include operating systems and application software. The plurality of electronic devices 10 is coupled to the control server 30 via network. The control server 30 is coupled to the storage server 50, which stores a plurality of installation files therein.

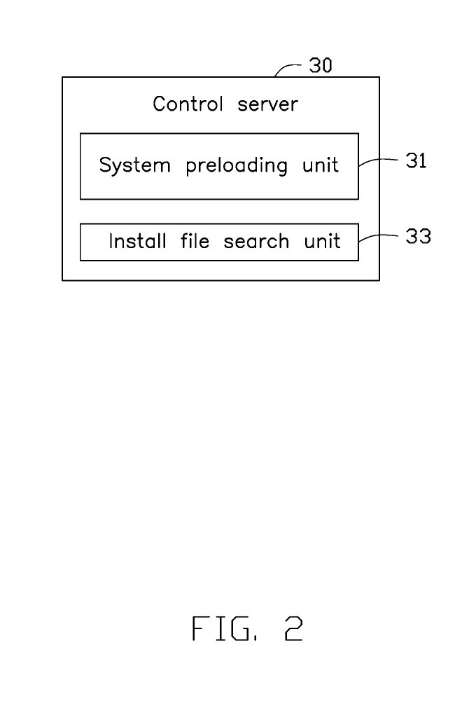

FIG. 2 illustrates the control server 30. The control server 30 includes a system preloading unit 31 and an installation file search unit 33. The system preloading unit 31 is configured to preload an application installation system in each electronic device 10. The installation file search unit 33 is configured to search through installation files in the storage server 50.

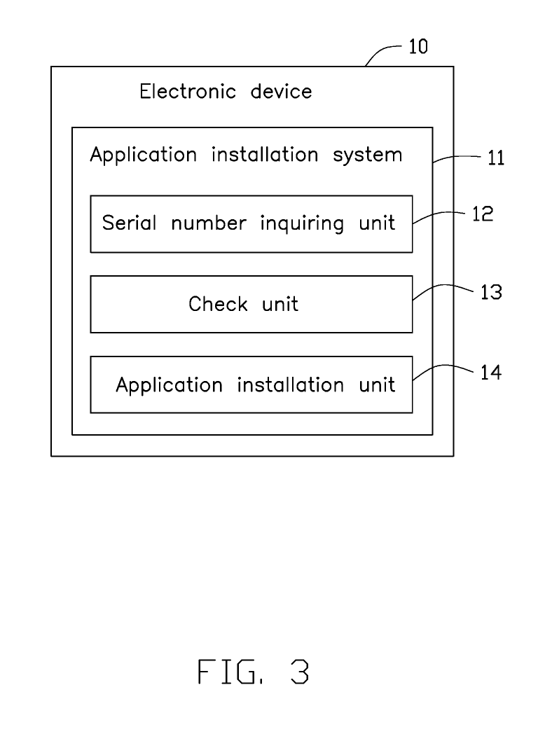

FIG. 3 illustrates the electronic device 10. The system preloading unit 31 of the control server 30 installs an application installation system 11 in the electronic device 10. The application installation system 11 includes a serial number inquiring unit 12, a check unit 13, and an application installation unit 14. The serial number inquiring unit 12 is configured to find and discover a serial number of the electronic device 10. Different electronic devices 10 have different serial numbers, so the serial number is an identification of the electronic device 10. The check unit 13 is configured to check that the installation file sent from the storage server 50 is complete. The application installation unit 14 is configured to run the installation file and install the application in the electronic device 10.

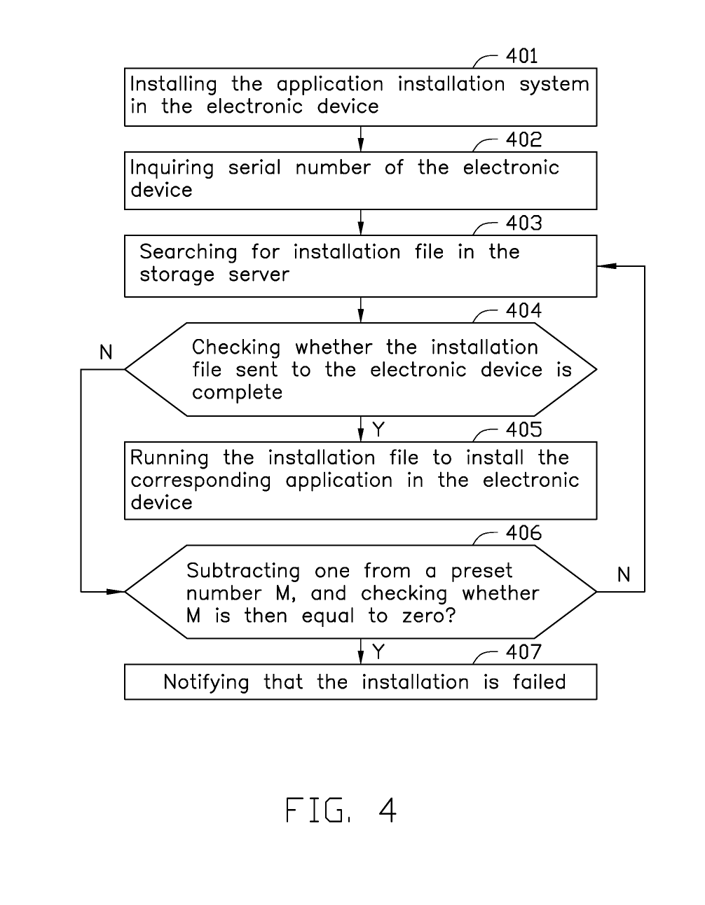

FIG. 4 illustrates a flow chart for automatically installing applications. The flow chart includes following steps.

At block 401, the method includes installing the application installation system 11 in the electronic device 10 by the system preloading unit 31 of the control server 30.

At block 402, the method includes inquiring serial number of the electronic device 10 by the serial number inquiring unit 12 of the application installation system 11.

At block 403, the method includes searching for installation file in the storage server 50, the correspondence of such installation file being based on the serial number of the electronic device 10, and sending the installation file to the electronic device 10.

At block 404, the method includes checking whether the installation file sent to the electronic device 10 is complete by the check unit 13. If yes, go to block 405. If not, go to step 406.

At block 405, the method includes running the installation file to install the corresponding application in the electronic device 10 by the application installation unit 14.

At block 406, the method includes subtracting one from a preset number M, and checking whether M is then equal to zero. If yes, go to step 407. If not, go to step 403. In one embodiment, the preset number M is two.

At block 407, the method includes notifying that the installation is failed.

In the above system and method for automatically installing applications, the control server 30 and the storage server 50 can install suitable applications in a plurality of electronic devices 10.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A system for automatically installing application for an electronic device, comprising:
a control server comprising a system preloading unit;
a storage server storing a plurality of installation files therein; and
wherein the system preloading unit is configured to preload an application installation system in the electronic device, the application installation system comprises a serial number inquiring unit, the serial number inquiring unit is configured to inquire a serial number of the electronic device, the control server is configured to search corresponding installation file in the storage server based on the serial number to install corresponding application in the electronic device.

2. The system of claim 1, wherein the control server further comprises an installation file search unit, and the file search unit is configured to search the corresponding installation file.

3. The system of claim 1, wherein the application installation system comprises a check unit, and the check unit is configured to check whether the corresponding installation file is complete.

4. The system of claim 1, wherein the application installation system comprises an application installation unit, and the application installation unit is configured to run the installation file to installation application in the electronic device.

5. The system of claim 1, wherein the electronic device is coupled to the control server via network.

6. A method for automatically installing application, the method comprising:
installing an application installation system in an electronic device by a system preloading unit of a control server;
inquiring a serial number of the electronic device by a serial number inquiring unit of the application installation system;
searching an installation file in a storage server based on the serial number of the electronic device; and
running the installation file to install corresponding application in the electronic device by an application installation unit of the application installation system.

7. The method of claim 6, wherein before the application installation unit runs the installation file, a check unit of the application installation system checks whether the installation file is complete.

8. The method of claim 6, wherein the electronic device is coupled to the control server via network.
